(19) United States
(12) Patent Application Publication
(10) Pub. No.: US 2026/0296856 A1
(43) Pub. Date: Oct. 1, 2026

(54) METHODS AND SYSTEMS FOR STABILIZING MOBILE MACHINES

(71) Applicant: Caterpillar Inc., Peoria, IL (US)

(72) Inventors: Jacob COMBS, Raleigh, NC (US); Henry R. HUDSON, Market Harborough (GB); David J. LOMAX, Clayton, NC (US); Robert CONRAD, Clayton, NC (US); Bradley J. HODGES, New Hill, NC (US)

(73) Assignee: Caterpillar Inc., Peoria, IL (US)

(21) Appl. No.: 19/092,540

(22) Filed: Mar. 27, 2025

(51) Int. Cl. B66F 9/075; B60G 17/015; B66F 9/065

(52) U.S. Cl. CPC B66F 9/07559; B60G 17/0152; B66F 9/0655; B66F 9/0755; B60G 2202/24; B60G 2204/45; B60G 2300/00; B60G 2400/25

(57) ABSTRACT

A telehandler includes: a body; a boom connected to the body and configured to pivot relative to the body about a boom axis; a rear axle pivotally connected to the body; rear wheels connected to the rear axle; a hydraulic assembly configured to control pivoting of the rear axle relative to the body, the hydraulic assembly including a hydraulic cylinder and a valve configured to open and close to permit and prevent hydraulic fluid flowing into and out of the hydraulic cylinder; and a controller configured to control the hydraulic assembly in a locked mode, an unlocked mode, and a damped mode, where the controller is configured such that, in the damped mode, the controller varies an amount the valve is open based on an angle of the boom.

### DESCRIPTION

### Technical Field

The present disclosure relates generally to mobile machines, and, more specifically, to methods and systems for stabilizing mobile machines.

### Background

Telehandlers (also called telescopic handlers) are mobile machines that include extensible telescopic booms for lifting, handling, and moving loads. Telehandlers are often used to place or transport heavy loads, and may be used on uneven terrain, for example in agricultural or construction environments. Telehandlers include both front and rear axles that are pivotally connected to a frame or chassis of the machine, so that the axles pivot and wheels on the axles contact the ground surface of a worksite, to stabilize the telehandler on the ground surface of the worksite. A tool, for example a bucket or fork, is provided at the end of the boom for handling loads. The extensible telescopic boom is pivotable relative to the chassis, such that the angle of the boom is adjustable, although the boom otherwise does not rotate relative to the chassis. As the boom is pivoted, the position of the load that is held by the tool changes relative to the chassis. This change in the position of the load results in a change in the center of gravity, and therefore a change in the stability, of the telehandler.

Telehandlers also include a hydraulic system that selectively locks the rear axle in place to prevent pivoting, as well as selectively unlocks the rear axle to allow the rear axle to pivot relative to the chassis. Generally, the hydraulic system unlocks the rear axle when the telehandler is traversing the ground surface, and the pivoting rear axle prevents the machine from tipping when the machine rides over bumps on the ground surface. Alternatively, the hydraulic system generally locks the rear axle when the telehandler is stationary and lifting a load with the telescopic boom and the tool, which prevents tipping of the machine. However, in some instances, when the telehandler is moving across the ground surface while carrying a load with the boom, and the rear axle is locked, a change in the center of gravity of the machine may result in one of the rear wheels lifting off of the ground surface, such that the telehandler may become unstable.

CN 115010019 A (“The '019 publication”) describes a machine with a telescopic arm. The machine described in the '019 publication locks or unlocks the rear axle depending on an angle of the telescopic arm when lifting a load. However, because the rear axle is either locked or unlocked, with no state in between for example, the machine described in the '019 publication may not be able to prevent tipping of the machine when lifting a load if a wheel lifts off of the ground surface.

Accordingly, systems and methods of the present disclosure may address or solve one or more problems in the art. The scope of the current disclosure, however, is defined by the attached claims, and not by the ability to solve any specific problem.

### SUMMARY

In some aspects of the disclosure, a telehandler comprises: a body; a boom connected to the body and configured to pivot relative to the body about a boom axis; a rear axle pivotally connected to the body; rear wheels connected to the rear axle; a hydraulic assembly configured to control pivoting of the rear axle relative to the body, the hydraulic assembly comprising a hydraulic cylinder and a valve configured to open and close to permit and prevent hydraulic fluid flowing into and out of the hydraulic cylinder; and a controller configured to control the hydraulic assembly in a locked mode, an unlocked mode, and a damped mode, wherein the controller is configured such that, in the damped mode, the controller varies an amount the valve is open based on an angle of the boom.

In some aspects, a telehandler comprises: a body; a telescopic boom connected to the body and configured to pivot relative to the body about a boom axis; a front axle pivotally connected to the body, wherein the front axle is configured to freely pivot relative to the body; two front wheels connected to the front axle; a rear axle pivotally connected to the body; two rear wheels connected to the rear axle; first and second hydraulic assemblies configured to control pivoting of the rear axle relative to the body, each of the hydraulic assemblies comprising a hydraulic cylinder and at least two valves configured to open and close to permit and prevent a flow of hydraulic fluid into and out of the hydraulic cylinder, respectively; and a controller configured to control the hydraulic assemblies in a locked mode, an unlocked mode, and a damped mode, wherein the controller is configured in the unlocked mode to position the valves in fully open positions, wherein the controller is configured in the locked mode to position the valves in fully closed positions, wherein the controller is configured in the damped mode to position the valves between the fully open position and the fully closed position.

In some aspects of the disclosure, a method of controlling a telehandler comprising a boom connected to a body which is configured to pivot relative to the body about a boom axis, a rear axle pivotally connected to the body, a hydraulic assembly comprising a hydraulic cylinder and a valve configured to open and close to permit and prevent a flow of hydraulic fluid into and out of the hydraulic cylinder, respectively, and a controller, the method comprises: with the controller: receiving a boom angle of the boom; determining that the boom angle of the boom is between a first predetermined angle and a second predetermined angle; and based on the determination, positioning the valve between a fully open position and a fully closed position, thereby permitting hydraulic fluid to flow into and out of the hydraulic cylinder

### BRIEF DESCRIPTION OF THE DRAWINGS

The accompanying drawings, which are incorporated in and constitute a part of this specification, illustrate various aspects of the disclosure, and, together with the description, serve to explain aspects of the disclosure.

FIG. 1 illustrates an isometric side view of a machine, in accordance with some aspects of the disclosure.

FIG. 2 illustrates an isometric view of a rear portion of the machine of FIG. 1, in accordance with some aspects of the disclosure.

FIG. 3 illustrates a schematic block diagram of a controller of the machine of FIG. 1, in accordance with some aspects of the disclosure.

FIG. 4 illustrates a schematic flow diagram of a method associated with the controller of FIG. 3, in accordance with some aspects of the disclosure.

### DETAILED DESCRIPTION

Both the foregoing general description and the following detailed description are exemplary and explanatory only and do not restrict the claims. The terms “comprises,” “comprising,” “having,” “including,” or other variations thereof, used herein cover a non-exclusive inclusion such that a process, method, article, or apparatus that comprises a list of elements does not include only those elements, but may include other elements not expressly listed or inherent to such a process, method, article, or apparatus. Further, relative terms, such as, for example, “about,” “substantially,” “generally,” “approximately,” or other variations thereof, include a possible variation of ±10% in a stated value, unless stated otherwise. Still further, the terms “one or more,” “at least one,” and variations thereof, include one, two, or more than two (e.g., a plurality). Additionally, terms such as “top” and “bottom” are exemplary only and may refer to an orientation of a component in a particular figure, for example, and do not require that the component is oriented such that a “top” is above a “bottom.”

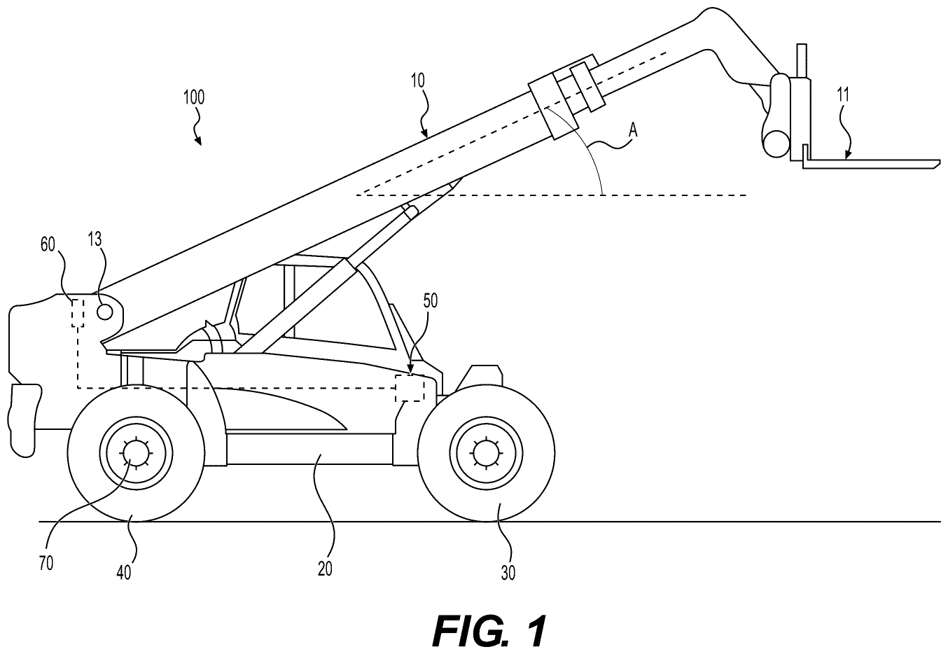

With reference to the drawings, FIG. 1 illustrates an isometric side view of a machine 100, in accordance with some aspects of the disclosure. Although the figures, including FIG. 1, illustrate the machine as a mobile machine in the form of a telehandler, aspects of the disclosure are equally applicable to other machines, such as for example other wheeled machines including wheel loaders, wheel excavators, and the like. Returning to FIG. 1, the machine 100 may include a telescopic boom 10, a body including a frame or chassis 20, a pair of front wheels 30 (only one shown in FIG. 1), a pair of rear wheels 40 (only one shown in FIG. 1), a controller 50, a sensor 60, and a rear axle 70, among other components.

The telescopic boom 10 may be an extensible, telescoping boom—e.g., an operator of the machine 100 may control the telescopic boom 10 to extend (e.g., increase in length), or retract (e.g., decrease in length). As FIG. 1 shows, the telescopic boom 10 may include a tool 11 which is attached at an end of the telescopic boom 10, the tool 11 being controlled by the operator of the machine 100 to pick up, carry, move, or otherwise manipulate a load on held on the tool 11. Although the tool 11 in FIG. 1 is illustrated as a forklift, the tool 11 may be a bucket, a platform, a grasping device, or another type of tool. The telescopic boom 10 may pivot relative to the chassis 20, such as about a boom axis 13. In some instances, the telescopic boom 10 does not otherwise pivot or rotate relative to the chassis 20, other than about the boom axis 13 (e.g., the telescopic boom 10 does not pivot about an axis perpendicular to the ground surface of the worksite).

The front wheels 30 may be pivotally connected to the chassis 20 by the front axle, such as at a single pivot point. The rear wheels 40 may be pivotally connected to the chassis by the rear axle 70, such as at a single pivot point. The front wheels 30 and the rear wheels 40 may rotate on their respective axles, as the machine 100 traverses the grounds surface of the worksite.

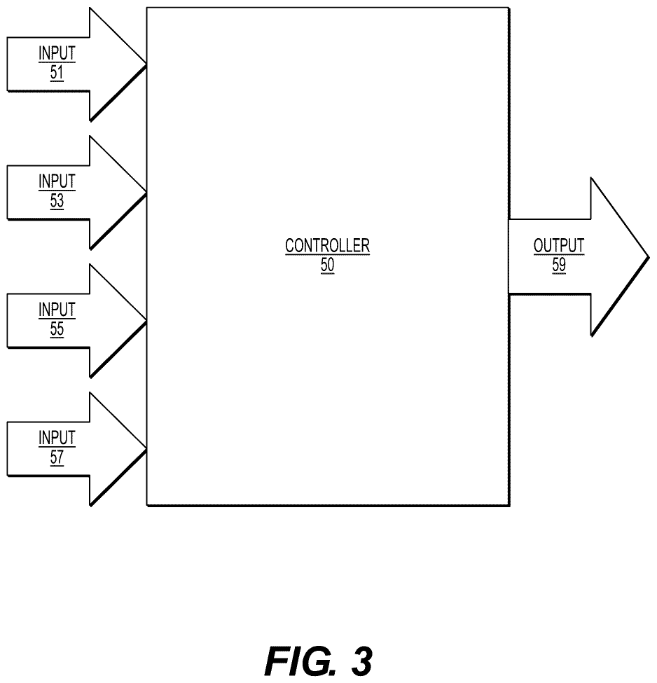

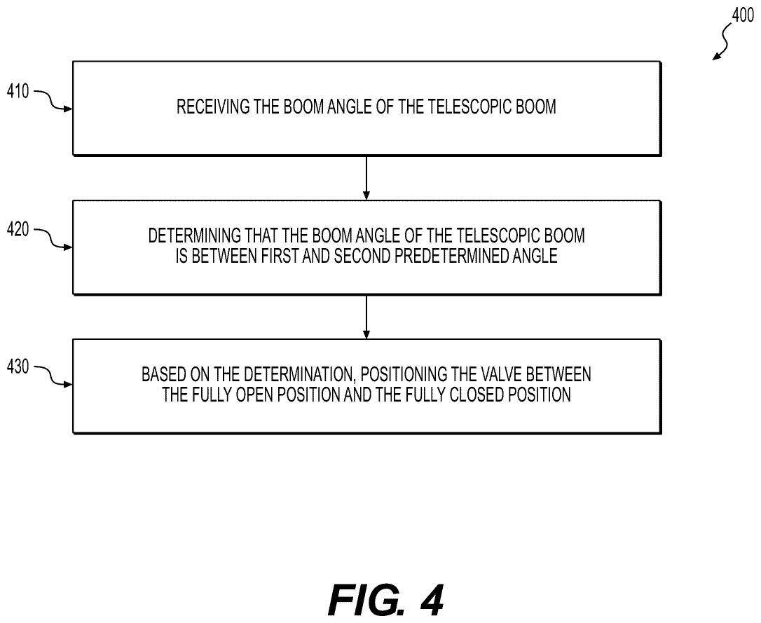

In accordance with some aspects of the disclosure, the controller 50 may embody a single microprocessor or multiple microprocessors. The controller 50 may form at least a portion of one or more systems for performing any of the operations mentioned herein. In some instances, the controller 50 may include a memory, a secondary storage device in addition to or other than the memory, a processor, such as a central processing unit, or any other system or systems for accomplishing a task consistent with the present disclosure. The memory or secondary storage device associated with the controller 50 may include non-transitory computer-readable media that store data or one or more software routines that may assist the controller 50 in performing its functions, such as the functions of method or process discussed with reference to FIGS. 3 and 4. Further, the memory or secondary storage device associated with the controller 50 may also store data received from the various inputs or sensors, including from the sensor 60, which are associated with the machine 100, including the inputs discussed below. Numerous commercially available microprocessors may be programmed or otherwise configured to perform one or more of the functions of the controller 50. In some instances, the controller 50 may include a general machine controller capable of controlling numerous other functions of the machine 100. Various other known circuits may be associated with the controller 50, including signal-conditioning circuitry, communication circuitry, hydraulic or other actuation circuitry, or other appropriate circuitry.

The sensor 60 may sense or measure a boom angle A that the telescopic boom 10 pivots about the boom axis 13. Although FIG. 1 illustrates the sensor 60 disposed proximate an end of the telescopic boom 10 which is closer to the boom axis 13, the sensor 60 may be installed at other locations on the telescopic boom 10, or may be installed at other locations on the machine 100, so long as the sensor 60 may sense the boom angle A of the telescopic boom 10. In accordance with some aspects of the disclosure, the sensor 60 may be an inertial measurement unit (IMU) that senses the boom angle A based on Earth's gravity, and the pivot A may represent an angle between a theoretical horizontal plane (e.g., Earth's horizon or a direction of travel of machine 100 on flat terrain) and a centerline of the telescopic boom 10. In accordance with some other aspects of the disclosure, the boom angle A may be measured relative to something else, such a portion of the machine 100 (e.g., the chassis 20).

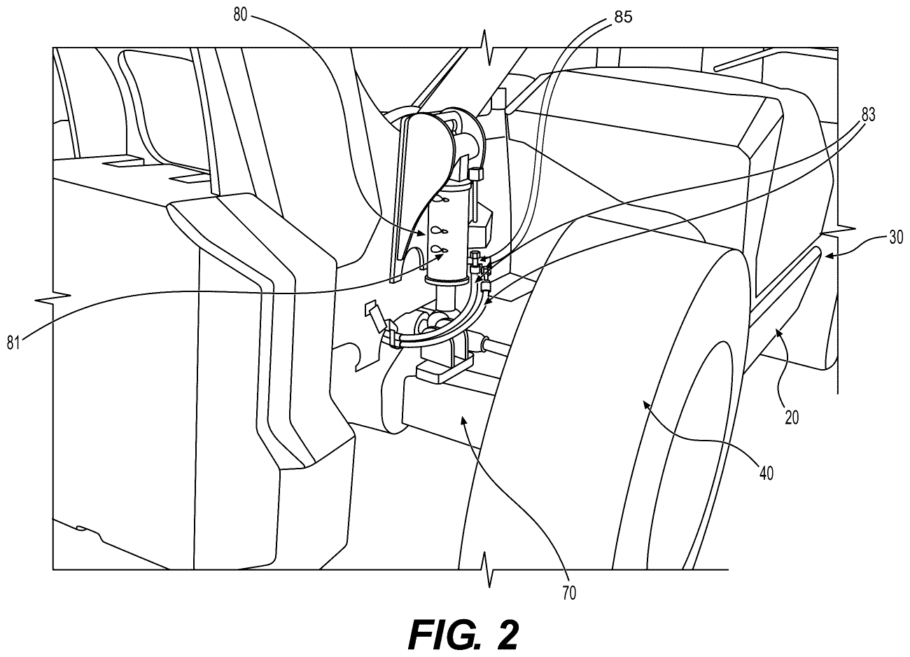

FIG. 2 illustrates a detail isometric view of a rear portion of the machine 100, with a portion of the chassis 20 and other components of the machine 100 omitted. As FIG. 2 shows, and as discussed above, the machine 100 may include the rear axle 70, which pivotally connects the rear wheels 40 to the chassis 20, and on which the rear wheels 40 rotate (e.g., the reax axle 70 may pivot as indicated by direction B in FIG. 2). As further described, the controller 50 may control the rear axle 70 in three modes—an unlocked mode, where the rear axle 70 is fully unlocked, such that the rear axle 70 may freely pivot relative to the chassis 20; a locked mode, where the rear axle 70 is fully locked and thus the rear axle 70 may not pivot relative to the chassis 20; and a damped mode, where the rear axle 70 may pivot relative the chassis 20 although the pivoting of the rear axle 70 is controlled. In accordance with some aspects of the disclosure, the controller 50 may transition the rear axle 70 to and from the unlocked mode, the locked mode, and the damped mode. In accordance with some aspects of the disclosure, the controller 50 may control an extent to which the rear axle 70 is damped (e.g., partially locked or partially unlocked) in the damped mode.

The machine 100 may include a hydraulic assembly 80 on each side of the machine 100 (only one hydraulic assembly 80 is shown in FIG. 2). Each hydraulic assembly 80 may include a hydraulic cylinder 81 and one or more valves 85 that control the flow of hydraulic fluid into and out of the hydraulic cylinder 81. Each hydraulic assembly 80 may be connected by hydraulic lines 83 to a hydraulic fluid source (not shown) that is common to both hydraulic assemblies 80, and a hydraulic pump (not shown) may be used to pressurize the hydraulic system to pump hydraulic fluid into and out of the hydraulic cylinders 81. The controller 50 may control operation of the hydraulic assemblies 80, to operate the rear axle 70 in the locked mode, the unlocked mode, and the damped mode.

As stated above, each hydraulic assembly 80 may include one or more valves 85, to control the flow of hydraulic fluid into and out of the respective hydraulic cylinder 81. In accordance with some aspects of the disclosure, the controller 50 may control the hydraulic assembly 80 to transition to the locked mode by moving the valves 85 of the hydraulic assembly 80 to fully closed positions, so that hydraulic fluid may not flow into or out of the hydraulic cylinder 81. As a result of the valves 85 fully closing so that hydraulic fluid may not flow into or out of the hydraulic cylinder 81, the position and length of the hydraulic cylinder 81 may not change, and thus the rear axle 70 may not pivot relative to the chassis 20. The controller 50 may control the hydraulic assembly 80 to transition to the unlocked mode by moving the valves 85 of the hydraulic assembly 80 to fully open positions, so that hydraulic fluid may freely flow into and out of the hydraulic cylinder 81. As a result of the valves 85 fully opening so that hydraulic fluid may freely flow into and out of the hydraulic cylinder 81, the position and length of the hydraulic cylinder 81 may change, and thus the rear axle 70 may freely rotate relative to the chassis 20.

The controller 50 may control the hydraulic assembly 80 to transition to the damped mode by moving the valves 85 to partially open (also referred to as partially closed) positions which are neither fully open nor fully closed, but instead between fully open and fully closed, so that the valves 85 may limit the flow rate of hydraulic fluid into and out of the hydraulic cylinder 81. As a result of the valves 85 being moved to the partially open position, the flow rate of hydraulic fluid into and out of the hydraulic cylinder 81 may be controlled, and thus the position and length of the hydraulic cylinder as well as pivoting of the rear axle 70 may also be controlled. In accordance with some aspects of the invention, when in the damped mode, the controller 50 may change the rate at which the rear axle 70 may pivot depending on the values of one or more inputs, including the boom angle A of the telescopic boom 10, which may be determined by the sensor 60. In accordance with some aspects of the invention, when in the damped mode, the controller 50 may change the rate at which the rear axle 70 may pivot depending on the values of one or more inputs, including a status of the parking brake, a service brake, or a transmission of the machine 100, among other inputs. In accordance with some aspects of the invention, when in the damped mode, the controller 50 may change the rate at which the rear axle 70 may pivot depending on the values of one or more inputs, a length or height of the telescopic boom 10, or tool 11. In accordance with some aspects of the disclosure, each hydraulic assembly 80 may include two valves 85, and in some examples the valves 85 may be solenoid valves 85. In some aspects of the disclosure, the controller 50 may control both of the hydraulic assemblies 80 together, such that both hydraulic assemblies 80 are in the locked mode, the unlocked mode, or the damped mode at the same time. In some examples, the controller 50 may control both hydraulic assemblies together in the damped mode.

FIG. 3 illustrates a schematic block diagram of the controller 50, in accordance with some aspects of the disclosure. As FIG. 3 shows, the controller 50 may receive one or more of inputs including boom angle signal 51, parking brake status signal 53, service brake status signal 55, or transmission status signal 57. In accordance with the above discussion, the boom angle signal 51 may include information regarding the boom angle A, such as from the sensor 60. The parking brake status signal 53 may include information whether the parking brake of the machine 100 is engaged or disengaged. The service brake status signal 55 may include information whether the service brake of the machine 100 is engaged or disengaged. The transmission status signal 57 may include information whether the transmission of the machine 100 is in neutral. In accordance with the above disclosure, based on the boom angle A, whether the parking or service brakes are engaged or disengaged, and whether the transmission is in neutral, the controller 50 may provide an output, such as a mode status signal 59 to control the hydraulic assemblies 80 to transition to the locked mode, the unlocked mode, or the damped mode, or control operation of the hydraulic assemblies 80 within the damped mode, and the mode status signal 59 may control the rate of pivoting of the rear axle 70 within the damped mode.

In some aspects of the disclosure, with reference to the damped mode, the controller 50 may store therein a map that correlates boom angles A to positions of the valves 85 of the hydraulic assemblies 80. In accordance with the above discussion, the map may store an inverse relationship between the boom angle A and the rate at which hydraulic fluid may flow into and out of the hydraulic assemblies 80.

Thus, in accordance with some aspects of the disclosure, the controller 50 may provide commands to open (e.g., fully open), partially open, or close (e.g., fully close) the valves 85 of the hydraulic assemblies 80, in accordance with the described unlocked, locked, and damped modes described above. The controller 50 also may output, as a component of the mode output signal 59 or as a separate output, a signal to a display within the cab of the machine 100, such that the display may display to the operator situated in the cab whether the machine 100 is in the locked mode, the unlocked mode, or the damped mode.

### INDUSTRIAL APPLICABILITY

In accordance with some aspects, the disclosure may provide systems and methods of stabilizing the machine 100, including a telehandler, which is carrying a load on the end of the telescopic boom 10, by controlling the rear axle 70 of the machine to transition among the locked, unlocked, and damped modes, as shown and described. In the damped mode, the rear axle 70 may be permitted to pivot, and the rate at which the rear axle 70 is permitted to pivot may depend on the boom angle A of the telescopic boom 10, as well as one or more other inputs.

In accordance with some aspects of the disclosure, the controller 50 may control the rear axle 70 to be in the unlocked mode under the following conditions: when the boom angle A is less than a first predetermined angle (e.g., about 20 degrees) and the parking brake is disengaged. In accordance with some aspects of the disclosure, the controller 50 may control the rear axle 70 to be in the locked mode under the following conditions: either i) when the parking brake is engaged; ii) when the boom angle is greater than a second angle (e.g., about 40 degrees) and either the service brake of the machine 100 is pressed or the transmission of the machine 100 is in neutral, or iii) when the machine 100 is turned off. In accordance with some aspects of the disclosure, the controller 50 may control the rear axle 70 to be in the damped mode under the following conditions: either i) when the boom angle A is greater than or equal to the first predetermined angle (e.g., about 20 degrees) and the parking brake is disengaged; or ii) when the conditions for the unlocked mode and the conditions for the locked mode are not met. In some aspects, the controller 50 may control the rear axle 70 to be in the damped mode when both of these conditions (condition i) relating to boom angle A and condition ii) relating to unmet conditions for the unlocked mode and locked mode) are met at the same time.

As further discussed below, in the damped mode, the controller 50 may control the hydraulic assemblies 80, such that the degree to which the valves 85 of the hydraulic assemblies 80 are open, and thus the rate at which hydraulic fluid may flow into and out of the hydraulic assemblies 80, is based on the boom angle A of the telescopic boom 10. For example, in accordance with some aspects of the disclosure, as the boom angle A increases from the first angle (e.g., about 20 degrees) to the second angle (e.g., about 40 degrees), the controller 50 may control the valves 85 of the hydraulic assembles 80 to open to a lesser extent. Thus, for example, when the boom angle A is closer to the first angle, the valves 85 may be open to a greater degree as compared to when the boom angle A is closer to the second angle that is greater than the first angle. Therefore, the rate at which hydraulic fluid may flow into and out of the hydraulic cylinders 81 of the hydraulic assemblies 80 may decrease as the boom angle A increases, because the extent to which the valves 85 are open is decreased. In some aspects of the disclosure, there may be an inverse relationship between the boom angle A and the rate at which hydraulic fluid may flow into and out of the hydraulic assemblies 80. Thus, in the damped mode, the controller 50 may vary the positions of the valves 85 and thus the amounts that the valves 85 are opened, which may vary the degree to which the pivoting of the rear axle 70 is damped.

FIG. 4 illustrates a flow diagram of a method 400 associated with the controller 50, in accordance with some aspects of the disclosure. As FIG. 4 illustrates, method 400 may include, at step 410, receiving the boom angle A of the telescopic boom 10. At step 420, the method 400 may include determining that the boom angle A of the telescopic boom 10 is between the first predetermined angle (e.g., about 20 degrees) and the second predetermined angle (e.g., about 40 degrees). Step 420, or another step, may also include determining whether the transmission is in neutral or otherwise engaged (such as with a transmission status sensor), whether the parking brake is engaged (such as with a parking brake status sensor), or whether the service brake is engaged (such as with a service brake status sensor). At step 430, the method 400 may include based on the determination, positioning the valve 85 between the fully open position and the fully closed position (e.g., operating the hydraulic assemblies 80 in the damped mode), thereby permitting hydraulic fluid to flow into and out of the hydraulic cylinders 81.

In some examples, the transition among or the operation within the modes may be automatic. For example, the controller 50 may move among or operate in the unlocked mode, the locked mode, and the damped mode of the rear axle 70 without user intervention (e.g., without an operator in the cab of the machine 100 initiating or otherwise choosing to enter any particular mode).

Thus, in accordance with aspects of the disclosure, the controller 50 may increase the stability of the machine 100 by damping the pivoting of the rear axle 70 when the telescopic boom 10 is used to lift loads. As the boom angle A increases, the damping of the rear axle 70 increases.

It will be apparent to those skilled in the art that various modifications and variations may be made to the disclosed system without departing from the scope of the disclosure. Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A telehandler, comprising:
a body;
a boom connected to the body and configured to pivot relative to the body about a boom axis;
a rear axle pivotally connected to the body;
rear wheels connected to the rear axle;
a hydraulic assembly configured to control pivoting of the rear axle relative to the body, the hydraulic assembly comprising a hydraulic cylinder and a valve configured to open and close to permit and prevent hydraulic fluid flowing into and out of the hydraulic cylinder; and
a controller configured to control the hydraulic assembly in a locked mode, an unlocked mode, and a damped mode,
wherein the controller is configured such that, in the damped mode, the controller varies an amount the valve is open based on an angle of the boom.

2. The telehandler of claim 1, further comprising a sensor,
wherein the sensor is configured to measure the angle of the boom,
wherein the controller is configured to receive the measured angle of the boom from the sensor.

3. The telehandler of claim 1, further comprising an inertial measurement unit,
wherein the inertial measurement unit is disposed on an end of the boom,
wherein the inertial measurement unit is configured to measure the angle of the boom,
wherein the controller is configured to receive the measured angle of the boom from the inertial measurement unit.

4. The telehandler of claim 1, wherein the controller is configured such that:
in the unlocked mode the controller fully opens the valve to permit hydraulic fluid to flow into and out of the hydraulic cylinder, and
in the locked mode the controller fully closes the valve to prevent hydraulic fluid from flowing into and out of the hydraulic cylinder.

5. The telehandler of claim 1, wherein the controller is configured to control the hydraulic assembly in the locked mode, the unlocked mode, and the damped mode, based on at least one of a state of engagement of a parking brake of the telehandler, a state of engagement of a service brake of the telehandler, or a state of a transmission of the telehandler.

6. The telehandler of claim 1, further comprising a front axle pivotally connected to the body.

7. The telehandler of claim 1, wherein the controller is configured to control the hydraulic assembly in the damped mode when the angle of the boom is greater than a first predetermined angle and less than a second predetermined angle.

8. The telehandler of claim 1, wherein the controller is configured such that, in the damped mode, the controller increases the amount that the valve is open as the angle of the boom decreases.

9. The telehandler of claim 1, wherein the controller is configured in the damped mode to decrease the amount the valve is open as the angle of the boom increases.

10. The telehandler of claim 1, wherein the controller is configured to control the hydraulic assembly in the locked mode when the angle of the boom is greater than a predetermined angle.

11. A telehandler, comprising:
a body;
a telescopic boom connected to the body and configured to pivot relative to the body about a boom axis;
a front axle pivotally connected to the body, wherein the front axle is configured to freely pivot relative to the body;
two front wheels connected to the front axle;
a rear axle pivotally connected to the body;
two rear wheels connected to the rear axle;
first and second hydraulic assemblies configured to control pivoting of the rear axle relative to the body, each of the hydraulic assemblies comprising a hydraulic cylinder and at least two valves configured to open and close to permit and prevent a flow of hydraulic fluid into and out of the hydraulic cylinder, respectively; and
a controller configured to control the hydraulic assemblies in a locked mode, an unlocked mode, and a damped mode,
wherein the controller is configured in the unlocked mode to position the valves in fully open positions,
wherein the controller is configured in the locked mode to position the valves in fully closed positions,
wherein the controller is configured in the damped mode to position the valves between the fully open position and the fully closed position.

12. The telehandler of claim 11, further comprising a sensor,
wherein the sensor is configured to measure an angle of the telescopic boom,
wherein the controller is configured to control the hydraulic assemblies in the locked mode, the unlocked mode, and the damped mode based at least in part on the measured angle.

13. The telehandler of claim 11, further comprising an inertial measurement unit,
wherein the inertial measurement unit is disposed on an end of the telescopic boom,
wherein the inertial measurement unit is configured to measure an angle of the telescopic boom,
wherein the controller is configured to control the hydraulic assemblies in the locked mode, the unlocked mode, and the damped mode based at least in part on the measured angle.

14. The telehandler of claim 11, wherein the controller is configured to control the hydraulic assemblies in the locked mode, the unlocked mode, and the damped mode based on at least one of a state of engagement of a parking brake of the telehandler, a state of engagement of a service brake of the telehandler, or a state of a transmission of the telehandler.

15. The telehandler of claim 11, wherein the controller is configured to control the rear axle in the damped mode when an angle of the telescopic boom is between a first predetermined angle and a second predetermined angle.

16. The telehandler of claim 11, wherein the controller is configured in the damped mode to vary position of each of the valves to be closer to the fully open position as an angle of the telescopic boom decreases.

17. A method of controlling a telehandler comprising a boom connected to a body which is configured to pivot relative to the body about a boom axis, a rear axle pivotally connected to the body, a hydraulic assembly comprising a hydraulic cylinder and a valve configured to open and close to permit and prevent a flow of hydraulic fluid into and out of the hydraulic cylinder, respectively, and a controller, the method comprising:
with the controller:
receiving a boom angle of the boom;
determining that the boom angle of the boom is between a first predetermined angle and a second predetermined angle; and
based on the determination, positioning the valve between a fully open position and a fully closed position, thereby permitting hydraulic fluid to flow into and out of the hydraulic cylinder.

18. The method of claim 17, further comprising:
sensing, with an inertial measurement unit, the boom angle of the boom,
wherein the receiving comprises receiving the boom angle from the inertial measurement unit.

19. The method of claim 18, wherein the sensing comprises sensing with an inertial measurement unit disposed on the boom.

20. The method of claim 17, further comprising:
with the controller:
receiving a status of at least one of engagement of a parking brake of the telehandler, a status of engagement of a service brake of the telehandler, or a state of a transmission of the telehandler; and
based on the received status and the boom angle, fully opening or fully closing the valve.
